(19) United States
(12) Patent Application Publication
(10) Pub. No.: US 2002/0128954 A1
(43) Pub. Date: Sep. 12, 2002

(54) Electronic trade confirmation system and method

(75) Inventor: Steven Douglas Evans, Hercules, CA (US)

Correspondence Address: DERGOSITS & NOAH LLP, Suite 1150, Four Embarcadero Center, San Francisco, CA, 94111, US

(73) Assignee: Regulus Integrated Solutions, LLC, Napa, CA

(21) Appl. No.: 09/999,842

(22) Filed: Oct. 24, 2001

Related U.S. Application Data
(60) Provisional application No. 60/243,230, filed on Oct. 24, 2000.

(51) Int. Cl. G06F 17/60

(52) U.S. Cl. 705/37

(57) ABSTRACT

A computer and network-based system and method for automatically and securely converting, distributing, storing and retrieving trade confirmation and statement data as electronic documents on the Internet for use by account holders and brokerage employees and for displaying the electronic documents in a format that resembles printed originals. The system adapts existing business printing data files or uses independent non-print data feeds to support the electronic documents. The system further operates to detect all documents delivered into its database and then automatically notify enrolled account holders via e-mail of the availability of such documents. Further, the system tests for successful delivery of the e-mail, and failure of delivery generates a customer notification and document delivery by other means. The system permits account holders and brokerage employees to search and retrieve new and archived electronic trade-related documents using database keys and date ranges. The system further provides flexible administration routines for use by authorized brokerage employees in order to designate levels of access for customer service and brokerage users, as well as ensuring that only authorized account holders can access their documents via encrypted authentication methods. The system includes routines having selection criteria for on-demand display, printing and downloading of management reports and individual electronic documents. The system design, functions and process are based upon regulatory guidelines for the securities industry regarding consumer notification, protection and informed consent, particularly with respect to acceptance of electronic documents in lieu of traditional print and mail delivery. Consumers have the ability to rescind or reinstate their consent at will to delivery of their trade confirmations and statements in electronic form.

### FIELD OF THE INVENTION

The present invention relates generally to information management systems, and more particularly, to electronic networks and systems configured to manage data regarding electronic trade transactions to provide secure reporting and confirmation of trades in compliance with SEC guidelines.

### BACKGROUND OF THE INVENTION

There have been numerous attempts to implement electronic information networks using computer-based systems. For example, U.S. Pat. No. 5,963,925 entitled Electronic Statement Presentment System describes a system that replaces the preparation and mailing of paper statements and invoices from a biller with electronic delivery, wherein the electronic statements have the same look as paper statements, as well as providing the capability for including video, audio, graphics, and custom enclosures. U.S. Pat. No. 5,790,790 describes an electronic document delivery system that sends a generic notification to an intended recipient, and the recipient can then download the document from a server using appropriate protocols. U.S. Pat. No. 6,192,407 describes an electronic document delivery system that dynamically generates a private URL which uniquely identifies the recipient and which is used to retrieve the document. U.S. Pat. No. 5,424,724 discloses a method and apparatus for enhanced electronic mail distribution.

### GENERAL DESCRIPTION OF THE INVENTION

1. Electronic Documents

The present invention is an Internet-based trade confirmation and statement system specifically tailored to the securities trading industry. The inventive trade confirmation and statement system provides the market with a uniquely integrated package of features and processes required by consumers (traders), securities brokers and government regulators. The system includes a combination of proprietary and non-proprietary software and hardware products and processes.

The system design incorporates features to insure compliance with the regulations of the Securities and Exchange Commission (“SEC”) for electronic document delivery. For example, there are proactive E-mail notifications on recent trade data sent to account holders. In addition, the system includes a complex set of business rules which track E-mail failures and detect when a trader accesses trade confirmation data on the host web site.

The system is fully integrated to provide printed paper statements as well as electronic confirmations. Therefore, brokers can easily comply with SEC regulations governing the request of a trader to revert from an electronic notification and document viewing system back to paper-based trade confirmations and statements. The system also includes integrated audit reporting to demonstrate SEC compliance regarding proof of delivery and trader consent.

The inventive electronic trade confirmation system is designed to let broker/dealers quickly and easily integrate electronic delivery of trade-related documents to enhance their on-line presence and availability of customer features.

Using the existing trade confirmation print stream, the present invention defines tools to create and deliver electronic trade confirmations and statements over the Internet, with proactive customer notification via E-mail. The trader selects a link in the E-mail to login in to the system and can begin viewing the latest trade confirmation data or retrieve activity regarding historical trades. To ensure compliance with SEC Proof of Delivery regulations, the system detects and monitors access to trade confirmations by all traders. At the option of the on-line broker, the system can export trade confirmation records which have not been accessed in a broker defined tolerance period to the host print facility to insure proof of delivery to the trader.

The system also offers an optional funds transfer module that allows traders to transfer funds from a bank checking account to their online brokerage account. The funds transfer module also contains a wallet database to confidentially store multiple credit card and checking account numbers in the event that brokers or one of their advertisers would like to promote e-commerce cross-selling with using the payments capability of the host.

2. Customer Service

The inventive trade confirmation system allows on-line brokers to improve customer service performance in a wide variety of ways, including a robust brokerage customer service module and customer query features for self-care. Beyond the simple convenience of viewing electronic trade confirmations, the inventive system offers a high level of accuracy, safety and reliability. The system allows on-line brokers to offer traders multiple and flexible ways to retrieve and organize historical trade data. The extensive self-care features of the system help reduce significantly customer inquiry costs and streamline call handling since customer service agents can review trade data online with customers.

3. Proof of Delivery

SEC regulations are vague regarding broker compliance on electronic proof of delivery. SEC guidelines suggest that the broker obtain a return-receipt E-mail notice from the trader to ensure that the electronic notification was successful. However, return-receipt E-mail is impractical with the SMTP (Internet) protocol. The proof of delivery method of the present invention incorporates a database design which is able to detect when a record has been retrieved by a trader and also tracks the amount of time between the settlement date and the trader confirmation review date.

Many brokers interpret the SEC proof of delivery regulation to imply that the broker must initiate a paper-based trade confirmation if the trader does not view the electronic trade confirmation within 72 hours. Other brokers believe that E-mail notification together with web availability sufficiently meet the minimum SEC regulatory requirement. The present invention is designed to accommodate either group and provides proof of delivery audit reports to demonstrate compliance.

The system was designed to enable on-line securities trading companies to meet the stringent NASD and SEC regulatory requirements pertaining to electronic delivery of trade confirmations as well as provide customer care features. The applicable regulatory guidelines driving the system design can be summarized as follows:

Electronic documents are permitted as long as each customer is notified that they have an electronic document to view.

For an electronic document to replace mail, it must be easy for the recipient to access.

A person receiving a document electronically must retain the ability to revert to receiving mailed paper documents, and must be able to obtain a paper copy of any electronic document on request.

The broker must verify that information provided electronically was actually received.

The customer must provide informed consent to receive information electronically.

The broker must verify that consent procedures are followed and have a way to verify that brokerage personnel comply with customer consent and de-consent instructions.

4. System Administration

The system includes a set of administrative features as typically required in on-line systems for maintenance and control by one or more system administrators to manage user access, information viewing privileges and changes to organization offices and codes. The administrative module consists of data capture screens used by the brokerage to add, modify and delete company offices, customer service representatives and account executives. This provides the means to define relationships within the system between customer service representatives and account executives and their ability to access customer accounts found within a single office, multiple offices or company division. These relationships are maintained in a table that is checked each time an internal user requests account information. An error message is displayed if the user attempts to access accounts that are not authorized by the administrative table.

### SUMMARY OF THE INVENTION

The inventive trade confirmation system thus enables securities trading companies to provide on-line presentation of trade confirmations and account statements to consumers combined with legally-required notification and compliance tracking features, customer care, data retrieval, system administration, trading account funds transfer capability and exception processing via corrective oscillation to print and mail mode.

The system also addresses consumer expectations for improved service, flexible products, timely information and transaction security. These features are all integrated into a single package for the first time.

The system is unique in terms of the software modules programmed to perform specific functions that are integrated within the overall design. These are discussed in more detail below. The result is a hybrid architecture that delivers printed and/or on-line viewing of trade confirmations and statements combined with several customer care features.

### BRIEF DESCRIPTION OF THE DRAWINGS

FIG. 1 is a schematic block diagram showing the inventive system for electronic trade confirmations.

FIG. 2 is a flow chart showing the processing steps for electronic presentment.

FIG. 3a is a screen shot showing the form for authorizing electronic delivery.

FIG. 3b is a screen shot showing the terms and conditions for electronic delivery.

FIG. 3c is a screen shot showing the form to rescind consent for electronic delivery.

FIG. 4a is a block diagram showing the e-mail notification process.

FIG. 4b is a block diagram showing the e-mail address update process.

FIG. 5a is a screen shot showing the authentication login.

FIG. 5b is a screen shot showing access to trade confirmations.

FIG. 5c is a screen shot showing export trade data.

FIG. 5d is a screen shot showing a trade detail statement.

FIG. 5e is a screen shot showing a user query.

FIG. 6a illustrates a CSR/AE query screen.

FIG. 6b illustrates a CSR/AE report.

FIG. 7 illustrates a screen shot showing audit history.

### DETAILED DESCRIPTION OF THE INVENTION

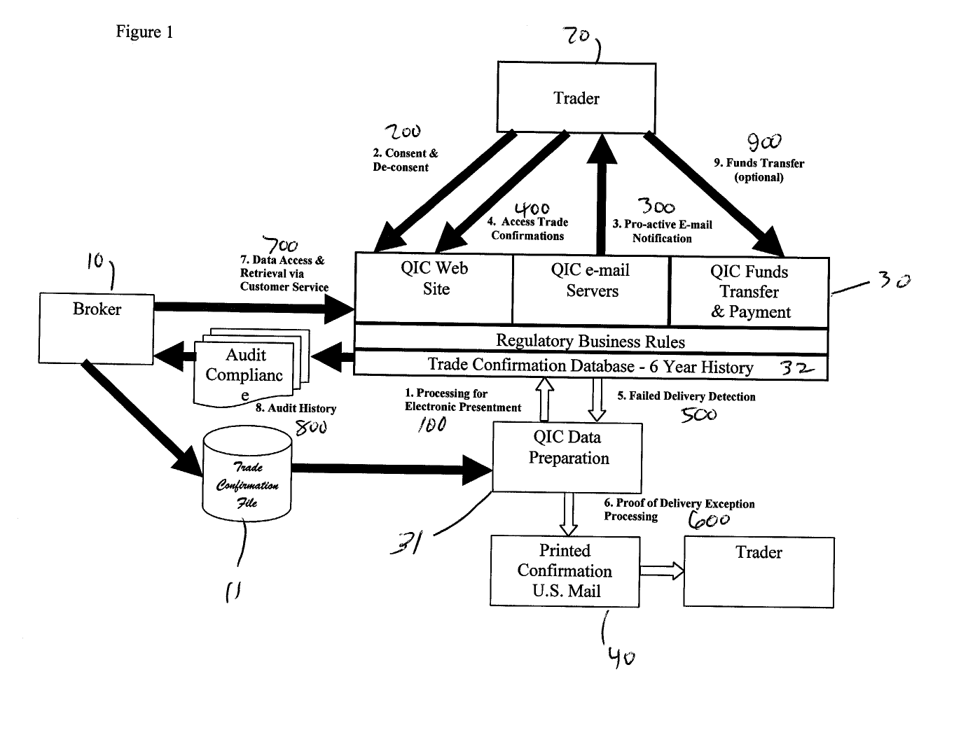

The present invention is a trade confirmation system but could be more generally considered an information and document management system. See FIG. 1 for an overview diagram of the system and its components. As shown in FIG. 1, the system includes an integrated set of software, hardware, print and mail processes for managing trade data as between a broker computer 10 and a trader computer 20. The trade data is managed through a host computer 30 that interacts with the broker computer 10 and trader computer 20. The host computer 30 includes sufficient resources for storage and processing of a large amount of trading data.

In a typical electronic trade transaction performed in accord with the present invention, the broker computer 10 provides trade confirmation data 11 to a data preparation module 100. The data preparation module 100 organizes the data and provides it to a database 32 in the host computer 30 for electronic presentment.

The database 32 is accessible to a trader computer 20 that has given proper consent via the consent process 200. Notifications of electronic document availability are made automatically via E-mail notification process 300. The trader 20 can then access the trade data via retrieval process 400.

If the trader 20 fails to access the trade data, that fact is detected by detection process 500. Then the data is also made available to a printing module via proof of delivery exception process 600, where a printed confirmation statement is generated and mailed to the trader. Additional features include a broker access process 700 for customer service, an audit process 800 for regulatory compliance and activity tracking and an optional funds transfer process 900 for online transfers to the client's brokerage account.

Each of these processes will now be described in more detail.

1. Processing for Electronic Presentment

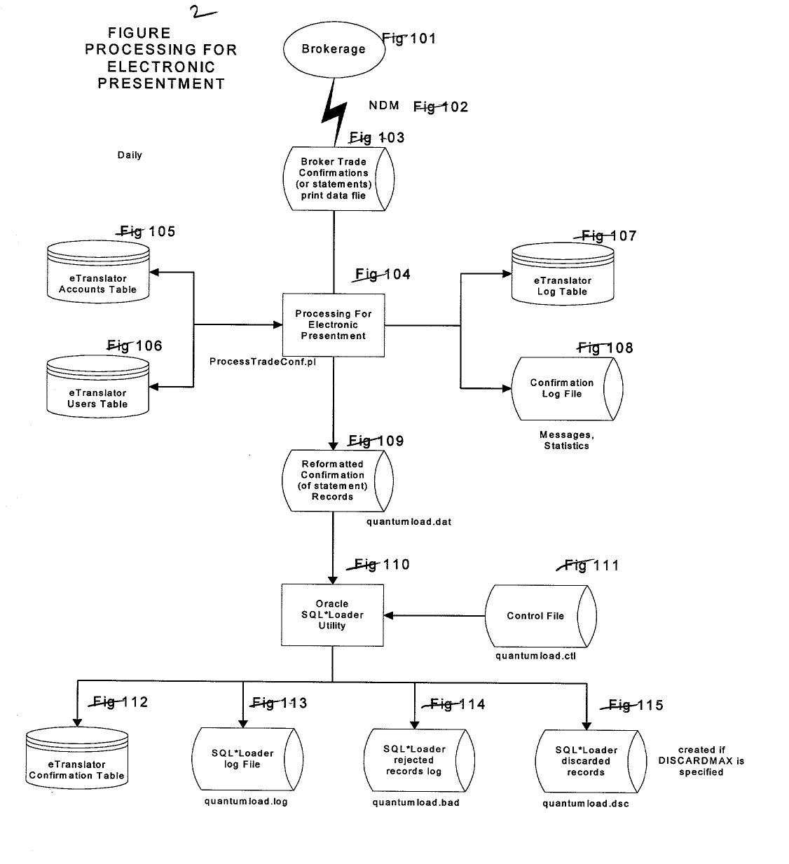

The electronic presentment process 100 uses unique data management programs to receive data in a variety of formats intended for print and then manipulate and transfer the data into databases for generation of customized electronic confirmations and statements. The programs performing these manipulations are prepared to read and normalize data from each unique document source file. The system processes files in formats such as Metacode, AFP, DJDE, and text-based data files. Because of this capability, brokerage firms that currently print confirmations themselves do not need to redesign their system to present electronic views since the inventive system can process any print-oriented file. For example, a Perl program is used to acquire and process the input data, as described below. FIG. 2 is a diagram of the load and data preparation process and also contains individual components corresponding to the numbered items described below.

The trade confirmation data is loaded from the host computer into an Oracle database 32 once daily for ultimate viewing by an end-user. Other document types such as statements are loaded on different schedules as required. The document data files consist of multiple record types including headers, detail and trailers. Only trade confirmations for those traders consenting to view trade data electronically can be retrieved from the database by the trader (see Consent and De-Consent process 200). Brokerage customer service representatives, as a function of internal client support activities, can view all electronic documents for each of their assigned customers in block 106 (see Process 700—Data Access & Retrieval for Customer Service).

The Trade Confirmation Load process handles receiving and loading a file of trade document records from the broker's system into an Oracle database for viewing by an end-user. The Trade Confirmation file contains trade confirmations for each trader. Similarly, statements or any other documents are received in a file to be processed for electronic presentment. A conventional daemon process continually runs to monitor when a file (block 103) has been received from the broker system (block 101). The file will be transmitted via conventional file transfer protocol, such as NDM, on a dedicated telecommunications line 102 to the host computer 30.

A Perl program is used to read, reformat and load the incoming data files identified above in block 104. The output files are the Load File of reformatted confirmations (or statements) (block 109), Oracle Accounts Table (block 105), Oracle Users Table (block 106), Oracle Log Table (block 107), and Messages Log (block 108). The Perl program also detects and adds new accounts to the accounts table 105 and user information to the user table 106, including E-mail address. This automated feature eliminates new account administrative maintenance and provides for immediate loading of records with both existing and new accounts for online viewing.

After the Perl program establishes a connection with the Oracle database, the main processing step 104 extracts the account number to determine if it is an active account. If so, the values associated with the extract fields (based on the file layout of the source file normally used for printing) for that account are written to a load record to be used in the SQL loader 110. Record totals will be used from the trailer record to balance against program-calculated totals (block 111). If the record totals do not match, the batch will be rejected. A rejected records log and discarded records file are updated for use by the brokerage to correct the account error information (blocks 113-115).

Following a successful extract, the program closes the load file and invokes the SQL loader utility to update the confirmation table 112. The program also places a unique date stamp on the trade confirmation file 103 and moves it to a backup directory for use in the event a re-run is necessary. Backup files are retained for one week in the host computer.

Advantageously, the system has a built-in Batch Audit feature that gives brokerages the ability to review output and interrupt or back-out loading to the database if desired This provides an extra quality management capability and ensures that the brokerage has maximum control over its customer data even after it leaves the broker computer.

There is preferably a preset sequence and time schedule for receiving the file into the data preparation database 31 from the broker computer (step 101), processing the data for electronic presentment (i.e., the Perl program described above) in step 100, and loading the data into the trade confirmation database 32.

All records are loaded into the database for electronic access regardless of viewing consent privileges invoked by traders. In this way, trade documents are immediately available as soon as a trader (user) consents to electronic document delivery.

From this electronic presentment processing, the most current trade records are added to the Oracle database for retrieval by the SQL queries and reports built into the electronic documents system, as discussed below.

2. Consent & De-Consent Processing (Process 200)

SEC guidelines require informed consent on the part of customers who agree to receive trade-related documents electronically. Consent can be provided in writing or via electronic means.

According to SEC regulations, a trader must receive a trade confirmation in the mail unless the trader explicitly consents to receiving the trade confirmation using another method. Mailed confirmations must be time-stamped within three days. An on-line brokerage may also present a trade confirmation electronically without the trader's consent, but may not unilaterally eliminate mail delivery of this confirmation without the trader's consent.

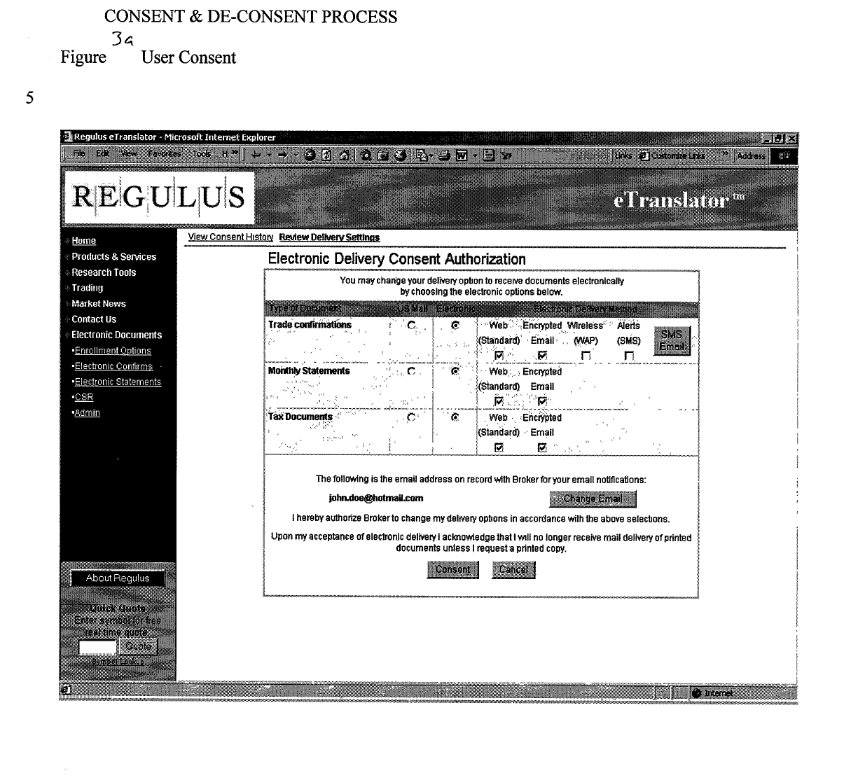

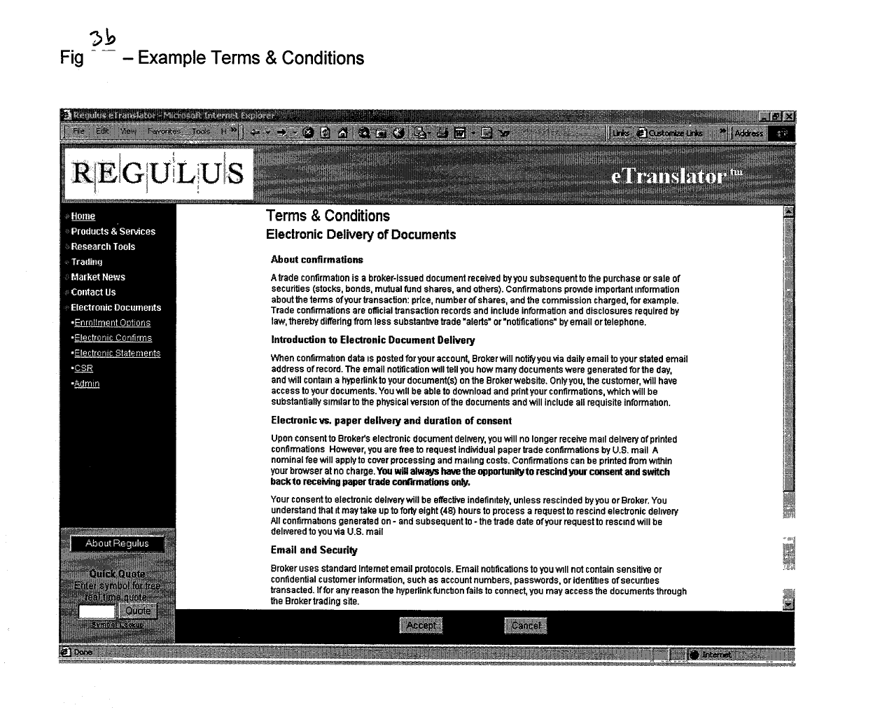

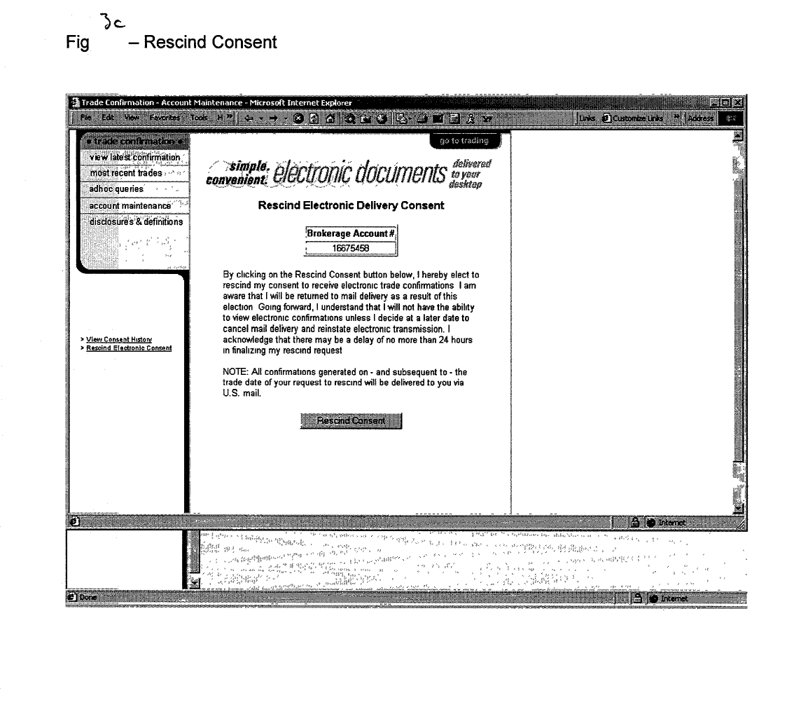

To meet this business requirement, the system is designed to determine if a customer has consented to electronic trade confirmations each time the customer accesses the system. If not, the system automatically displays a consent form as shown in FIG. 3a followed by a terms and conditions form as shown in FIG. 3b. Several options may be provided to the user as specified by the brokerage, as shown in the options matrix in FIG. 3a, wherein multiple document types are made available, means of delivery and offered, including type of electronic delivery mode.

The system will only display electronic data after the customer has completed the consent process, at which time any accumulated data from the electronic presentment processing can be displayed immediately. The immediate access is a unique design feature that is achieved by loading all trade confirmations for all accounts in a secure database in step 100 regardless of consent status on each account. This permits immediate online document access when consent is given.

SEC regulations further require that the online brokerage allow the trader to reverse the electronic presentment of the trade confirmation by rescinding consent so as to not receive electronic delivery of trade confirmations and statements, and to revert back to trade document delivery through the mail. The electronic form provided to rescind consent is shown in FIG. 3c. The inventive system provides a seamless transition from print to electronic and back to print by linking the inventive system programs to the printing system programs.

Before being allowed to view any trade confirmations, traders must first consent to receiving their confirmations on-line and accept the terms and conditions. The following processes are contained in the dialog between the trader computer 20 and host computer 30. A trader may also rescind consent at any time. If this occurs, the trader must re-consent before being allowed to view confirmations on-line again. The system keeps a record of every time a trader consents or rescinds consent in a consent history file for audit compliance (see process 800). The trader can view this consent history at any time and may also view the terms and conditions page at any time.

The following outlines summarize an exemplary accept or rescind processes which control the traders ability to view electronic documents. The processes also update the audit history log to enable the broker to comply with requirements to demonstrate trader acceptance to receive electronic versus printed documents:

Pseudocode for Consent to Electronic Delivery:

Display the AccountNumber

Display an HTML form with two input buttons—“Consent” and “Cancel”

Get the UserRole from the session object

If the UserRole is “CT”

Display the E-mail prompt on the screen

Display the confirm E-mail prompt on the screen

End

When the user selects one of the buttons, the Main servlet is called with the following parameters:

Page=“ConsentUpdate”

If the user selected “Consent” then Consented=“Consent”

If the user selected “Cancel” then Cancelled=“Cancel”

Pseudocode for Rescind Consent to Electronic Delivery:

Retrieve the account number from the Account session variable and display it

Display a check box and a Cancel button

If the user selects the check box

Display the Accept button

End

If the user clicks “Rescind”

Set Page=“RecentTradesDetail”

End

If the user clicks “Rescind”

Set Page=“Rescind”

Set Rescinded=“Rescind”

Pseudocode for Terms & Conditions Display and Acceptance:

If the user clicked the “consent” button above,

Display the terms and conditions page having accept or cancel buttons at the bottom of the page

If the user clicks “Accept”

Display the list of most recent documents for that account number

If the user clicks “Cancel”

The system tells the user that the Terms and Conditions must be accepted to use electronic documents

The Terms and conditions page is redisplayed

If the user wants to exit, they click “Back” on their browser

3. E-Mail Notification (Process 300)

SEC guidelines require that if a securities document is provided on an Internet site, a notice must be made separately in a timely fashion to inform customers that the document is available for viewing. The system solution to this is an E-mail notification followed by printed and mailed notice in the event that the E-mail attempt is rejected. This ensures compliance with SEC and NASD guidelines requiring timely and accurate notice to customers that information is available electronically for viewing. A link within the E-mail will direct the trader to a login area at the brokerage site for authentication. Once the trader has authenticated at the login area, the account number is encrypted and the trader is referred to a host site where the electronic confirmation can be viewed.

In the case of multiple trades within the same day, the system is designed to send the trader one E-mail for all trades at the account number level occurring that day unless the client prefers otherwise. The text message in the E-mail contains the number of trades encountered for that batch as detected in the host system database 32.

The E-mail notification system has other built in features related to electronic notification that exceed industry requirements and surpass the functions performed by competing products, as noted below.

Mail Notification Process

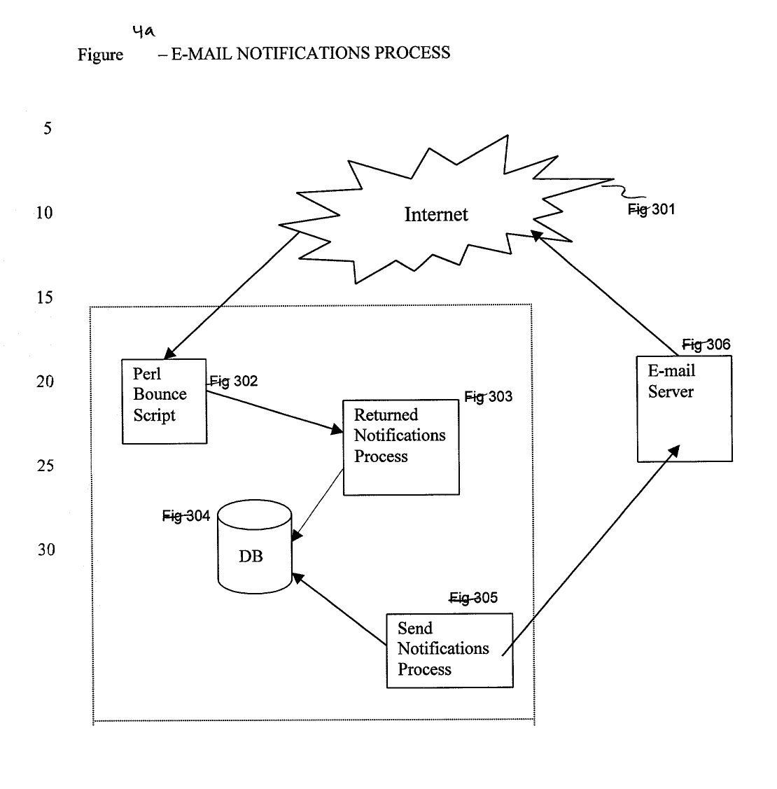

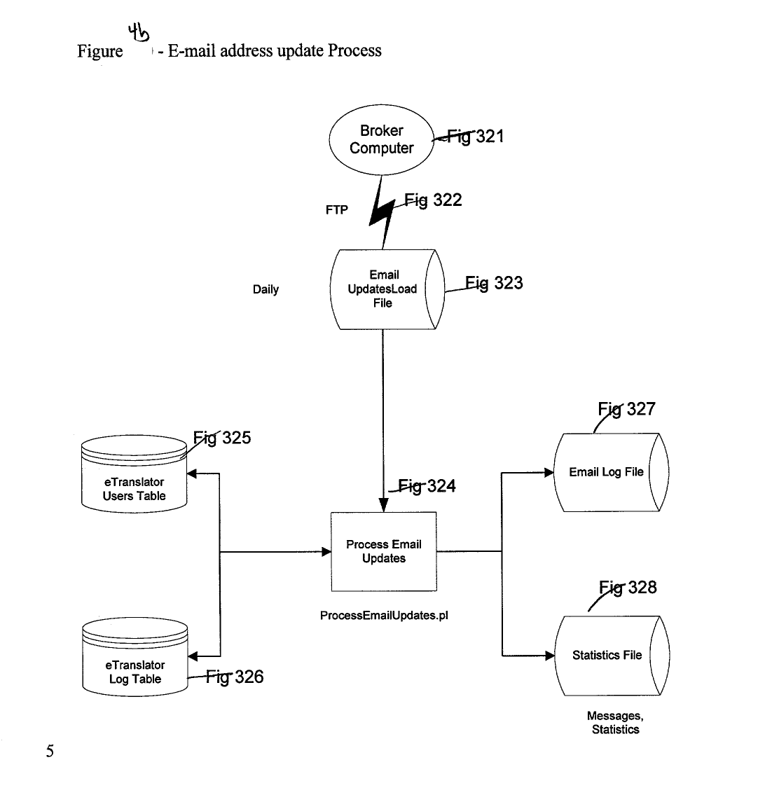

With reference to FIG. 4a, a send notification process 305 is run each day to identify all accounts for which new confirmations have been loaded by the electronic presentment processing 100. These accountholders are then sent an E-mail notification generated by the send notification process, informing them that they have new confirmations available for viewing. The system refers to an E-mail address table 106 to select the address associated with each account having a trade confirmation or other document loaded for electronic viewing.

The notification message is routed through an E-mail server 306 over the Internet 301 to the E-mail address of record. If an account has more than one new confirmation on a given day, only one E-mail notification will be sent. When the confirmation notification is sent, the time and date sent will be recorded in the database 304.

If an E-mail is returned because of an invalid address, the database record will be updated with an error code indicating an invalid address in process 303. This enables the customer service representative at the brokerage to distinguish between notifications which failed due to faulty addresses which can be rectified administratively, versus failures due to telecommunications problems or other one-time external problems.

If an E-mail is returned for any reason, a Perl script is run in block 302 to compare the date and time it was initially sent with the current date and time. If the difference is greater than eight hours, the mail will not be resent. This rejection process initiates the “Proof of Delivery Exception Process” 500.

E-Mail Address Update Process

Since the system automatically sends E-mail to traders as a proactive notification, a process is built into the system for maintaining updated E-mail addresses via a daily E-mail address update load, as shown in FIG. 4b. New and corrected E-mail addresses are updated in the brokerage E-mail address directories, which can be passed to the host computer 321 from the broker computer in the form of an E-mail address update file 323 via a file transfer process (“FTP”) 322 for updating. In this way, E-mail failures on subsequent attempts are eliminated and the E-mail directory contained in the host computer and referenced by the E-mail services, is kept up to date via on-going reject processing.

The E-mail Update Load process 324 is responsible for receiving and loading E-mail updates for Retail traders who are users of the eTranslator system. The E-mail Update Load process updates the host system database 30 and is used in conjunction with each account number to validate that they are currently a user of the system by polling the Oracle users table 325 and the Oracle log table 326. The E-mail address file updates the respective Oracle table containing user information in the database 30.

Preferably, one E-mail Address Update file is received daily, Monday through Friday, excluding Market holidays. The file is transmitted via an NDM process on a dedicated circuit between the broker system 10 and the trade database 30. A daemon process will continually run to monitor when a file has been received by the host. The E-mail address update files are sent by the system after the Trade Confirmation Load file has been successfully processed. This will ensure that any new accounts that have been added to the database 32 by the Trade Confirmation Load process have their E-mail addresses updated to occur on the same day and prior to the E-mail notification being sent. A Perl program will be used to acquire and process the input data. Once a file has been detected, the Perl program will process the E-mail Update File.

The detail records contain the actual E-mail update information for each eTranslator account which has recently changed their E-mail options. If E-mail updates are received for an account not in eTranslator, the E-mail address record will be written to a rejected records file 328.

File record totals will be used from the trailer record to balance to calculated totals 327. If the record totals do not match, the batch will be rejected and the appropriate personnel notified to correct the problem. After the file is successfully processed, it will be backed up to a directory in the event that a re-run is necessary.

4. Access to Trade Confirmations (Process 400)

Before being allowed to view any trade confirmations, system users must first be authenticated. For retail traders, the authentication will take place at the broker computer site 10, and the encrypted account number will be forwarded to the host site for validation.

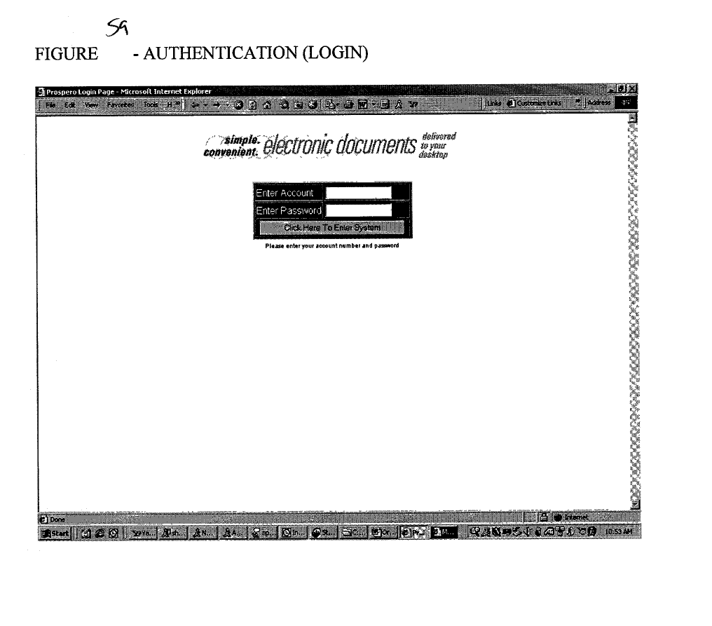

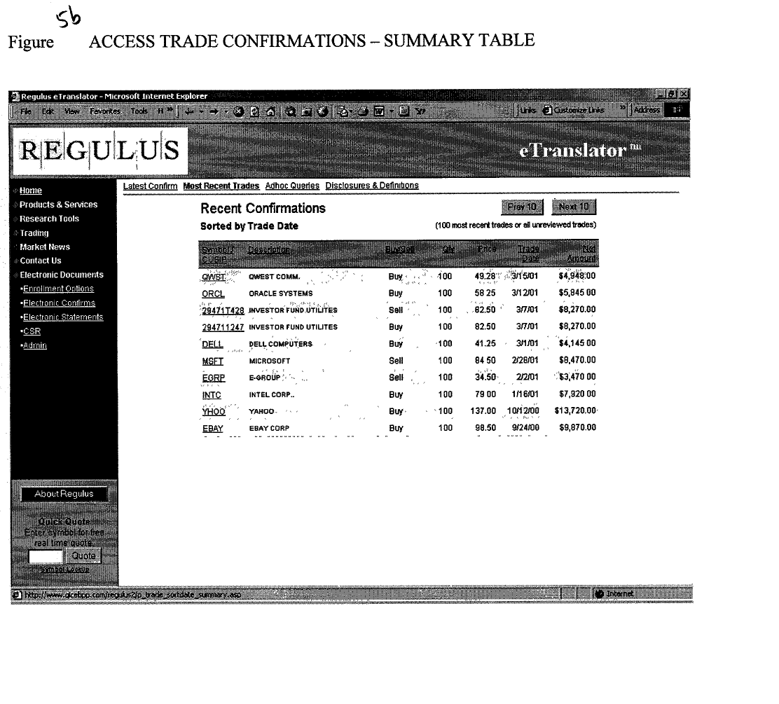

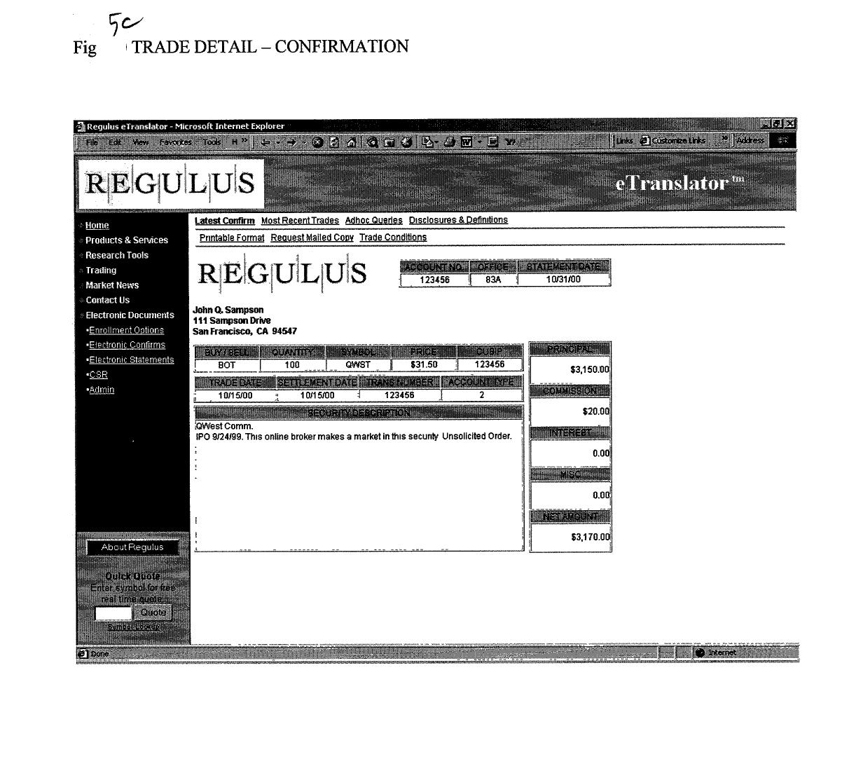

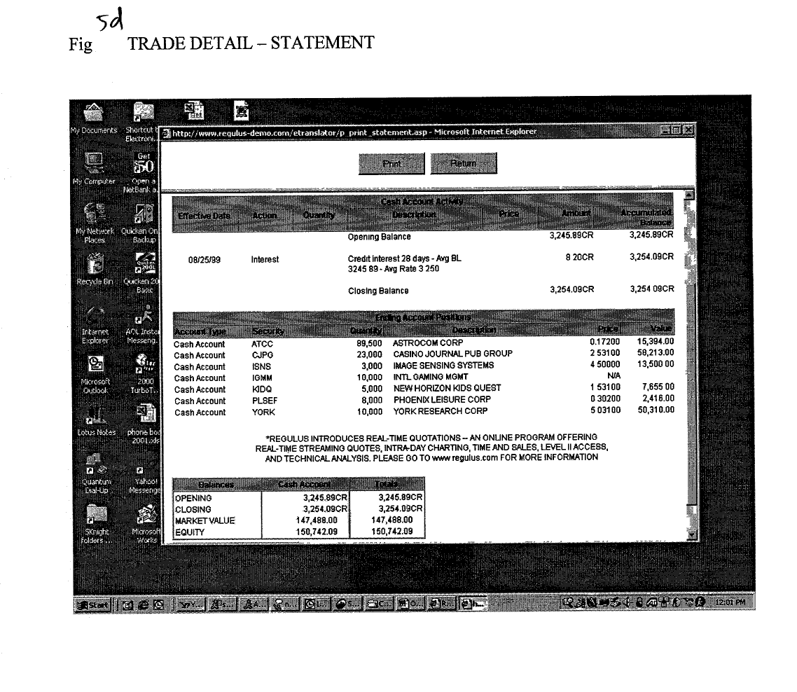

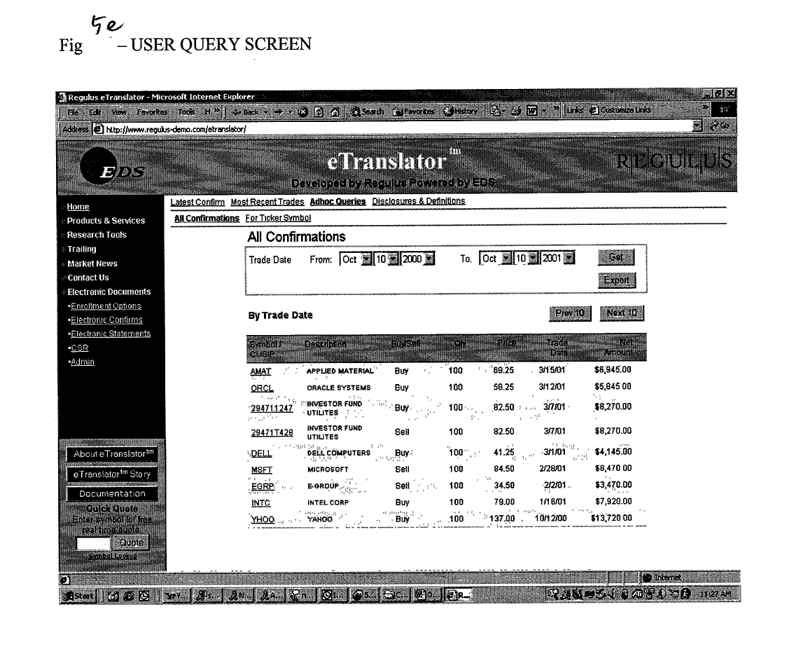

Commercially available encryption software is utilized to encrypt the account number combined with the trader's E-mail address to form a text string that authenticates the user between the trader computer 20 and the host computer 30. This is the most common way traders access the host, but other ways of accessing the host can be made available in the system, such as via a link through the broker computer. Correspondent traders, customer service representatives, internal brokers and administrative users are authenticated directly at the host. Upon the first successful logon, everyone except the retail trader is be forced to change their password. A typical login screen that executes the authentication sequence is shown in FIG. 5a.

Retrieve Trade Data

Since regulators view a mailed document as a convenient and reliable method for a consumer to access information, another SEC guideline requires that information provided electronically, in lieu of mail, must be similarly convenient and non-burdensome to access. The inventive system solution is based on a software design and technical environment that provides easy location and rapid retrieval of the electronically-stored customer information from the trade confirmation database 32. To meet the rapid access requirement, the system uses state-of-the-art communications equipment and interfaces, pre-coded queries accessing simple databases, and expandability to maintain retrieval speed as user volume increases.

For ease of use, the system displays a table of the most recently loaded record dates, sorted by date in descending order with the most current date first, as shown in FIG. 5b. This is the first page existing users see upon authentication and login. New users must first consent and agree to terms and conditions (see process 200) and then will see the most recent records page. The records are displayed in a summary table with a maximum of ten rows being displayed at a time. Buttons for the previous ten transactions (Prev 10) and the next ten transactions (Next 10) are displayed as needed to allow the trader to page through the list of trade documents.

The customer can select the desired effective date, which is a highlighted link to the detailed document for that particular date (statement or confirmation). When this link is selected, the database returns an HTML view of the requested document. With the detailed document, the system also provides a “Printable Format” button that, when clicked, re-displays the current document in full-screen view with system headers and menus removed. In this way, the user can use the print button on his computer's browser to generate a copy on the local printer connected to the trader computer 20.

An example of a retrieved confirmation detail is shown in FIG. 5c, and a retrieved statement detail is shown in FIG. 5d.

Query Trade Data

The user has the ability to perform ad hoc queries of their confirmations and statements. A typical user screen is shown in FIG. 5e. The parameters of the query are stock symbol and trade date range which are typed in to the displayed areas by the user. After the user enters the parameters, either a “Get” button or an “Export” button are selected. Queries are pre-programmed SQL calls to an Oracle database that are initiated when the trader clicks the “Get” or “Export” button. The “Get” (or “View”) selection displays the results of the query on the screen in HTML format and the “Export” selection button offers a download of the query in a comma-separated format as noted below.

Export Trade Data

The export functionality allows the trader to execute a query and then download the results to a spreadsheet. When the download request is made by clicking the “Export” button, the host system runs a program that reformats the document from the database 32 into a comma-separated format in a file which is downloaded to the trader computer.

Request Printed Copy

SEC guidelines state that a customer must have the ability to obtain a paper copy of an individual electronic document at any time, and must be assured that a paper version of the documents will be printed and mailed if consent for electronic receipt is revoked. The system solution to the ad hoc request for a paper copy goes beyond the ability of browsers to print a copy of the electronic document, which the company does not consider an adequate print option based on the systems strict interpretation of compliance with securities industry guidelines. Therefore, in addition to browser-based printing as described above, the trader can make a menu selection that automatically generates a printed and mailed document. A program containing code to update the Proof of Delivery Exception Processing function (see process 600) is used when the trader selects the Request Mailed copy option.

5. Failed Delivery Detection (Process 500)

Under SEC guidelines regarding proof of delivery, broker/dealers must have reason to believe that electronically delivered information has satisfied the delivery requirements under federal securities laws, and therefore broker/dealers must establish pro-active procedures to verify delivery occurred as intended.

The guidelines state that procedures evidencing satisfaction of the delivery requirements include: (1) obtaining an informed consent from an investor to receive the information through a particular electronic medium—coupled with assuring appropriate notice and access; (2) obtaining evidence that an investor actually received the information, for example, by electronic mail return-receipt or confirmation of accessing, downloading, or printing; (3) disseminating information through certain facsimile methods; (4) an investor's accessing a document via a hyperlink to a required document; and (5) using forms or other material available only by accessing the information.

Although Electronic Proof of Delivery is subject to numerous interpretations, the inventive system supports a strict interpretation and requires a trade confirmation to be printed and mailed under the following circumstances:

Prolonged web site failure

Failure of proactive E-mail notification

Trader has requested a printed copy

Trader rescinds electronic consent

The inventive system uniquely addresses these regulatory guidelines in two ways. First, the system proactively notifies users by E-mail that it has loaded the account holder's new trade confirmations and statements and that they are available for on line viewing. Advantageously, the system tracks failed delivery messages in the event of a delivery failure for any reason and as such, the E-mail servers in the host system 30 repeatedly transmit E-mail notification messages for a specified period of time (default is 8 hours) as long as failed E-mail messages continue to be received. At the end of the specified repeat delivery time frame, a program is executed which notifies the print exception processing function to generate a printed and mailed copy of the document (see process 600). A log file 304 is built each day to record customer accounts having a failed E-mail address. From the log file, the brokerage can administratively correct faulty E-mail records in their account holder's profile.

The second process for uniquely meeting the regulatory guidelines is proactive logging of user access to online documents after they are loaded in the database. Since electronic return mail (proof of receipt) can never be guaranteed in the E-mail environment, proof of receipt can only be proved by tracking an investors' access to a document retrieved from the database. The system is designed with detection and tracking mechanisms to determine that traders have accessed a record by using a specific hyperlink in the path to the electronic documents.

6. Proof of Delivery Exception Processing (Process 600)

After the unsuccessful proof-of-delivery is confirmed, the system automatically notifies the print processing program to retrieve the appropriate data from the confirmation database 32, print it in the correct format and distribute it to the customer by mail. This transition is made possible by logging a list of electronic document account numbers having failed E-mail notifications for that day's business and submitting them for print processing. This procedure can be either automatic or processed by customer service representatives depending on the operational preference of the brokerage.

In addition, the log file of rejected E-mail addresses is combined with other relevant trader information so the brokerage can research and correct the faulty E-mail addresses. The rejection record includes a value indicating the document link (identifying the specific document) that was being sent.

For any user who has not specifically consented to receive electronic documents, the system is designed to print and mail trade confirmations as a default setting for every registered trader's account. Unless the system is explicitly told by a trader that they consent to electronic delivery, the confirmation will be printed and mailed. If the consent is not invoked or if it is rescinded, or if Email notification failure is detected, the system automatically defaults that day's processing to the print and mail status.

This process is performed using a consent log file stored in the host computer 30. Each day, the system updates a file containing the latest list of account numbers for all traders who have consented to receive their confirmations electronically. Any trader who rescinds consent or whose Email notifications fail, will be deleted from this daily list.

The file is compared to a list of all account numbers registered in the system as recipients of printed documents. Any account which does not appear on the daily consent file list will automatically have its confirmation printed and mailed through exception processing. This process ensures that the default is to print and mail confirmations to conform to regulatory requirements, unless the system forces a no-print status via the up-dated consent file list.

7. Data Access & Retrieval Via Customer Service (Process 700)

The system is designed with customer care functions to enable a Customer Service Representative to respond to customer requests and to perform significant query and report functions for internal operations, customer information and research. The Customer Service Representatives (CSR) and Account Executives (AE) have the ability to select from nine different queries. The system will check to determine if the CSR and AE are authorized to view the account data by doing a table look-up on office, user and company codes entered by the system administrator. For CSR's, the authorization will be by office code level for each correspondent code. For AE's, the authorization will be by a combination of office code within correspondent code and AE code. A CSR has more privileges than an AE.

Customer service Queries include searching the database 32 for: “Trades by Account,” “Trades by Social Security Number,” “Trades By Trader Name,” “Trades by CUSIP number,” “Trades By Transaction Number,” “Trades by Ticker Symbol,” “Unreviewed Trades,” “Mail Delivery Requests.”

Customer service Reports include searching the database and displaying PDF report formats for: “Broker Blotter,” “E-mail Delivery Rejections,” “Account Detail Activity,” and “Electronic Confirmation Consent.” The report format is specific to the individual brokerage and the system programs are designed accordingly.

These customer service and account executive functions designed for the on-line brokerage personnel are included in the system to enable them to provide assistance to traders using the system and contacting the brokerage for customer service. They also provide internal management information utilizing the same data stored for electronic presentment.

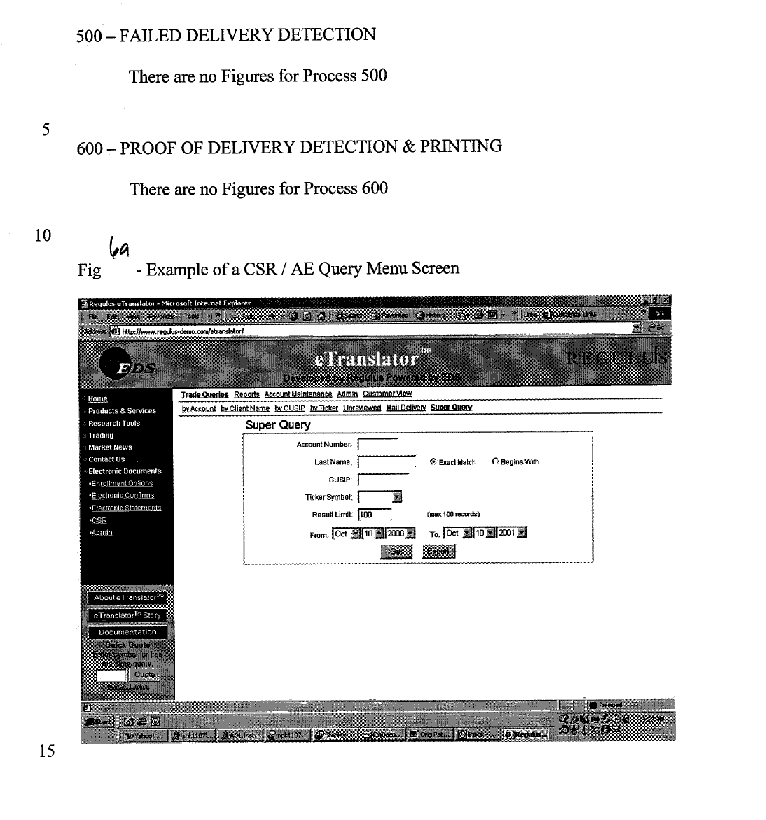

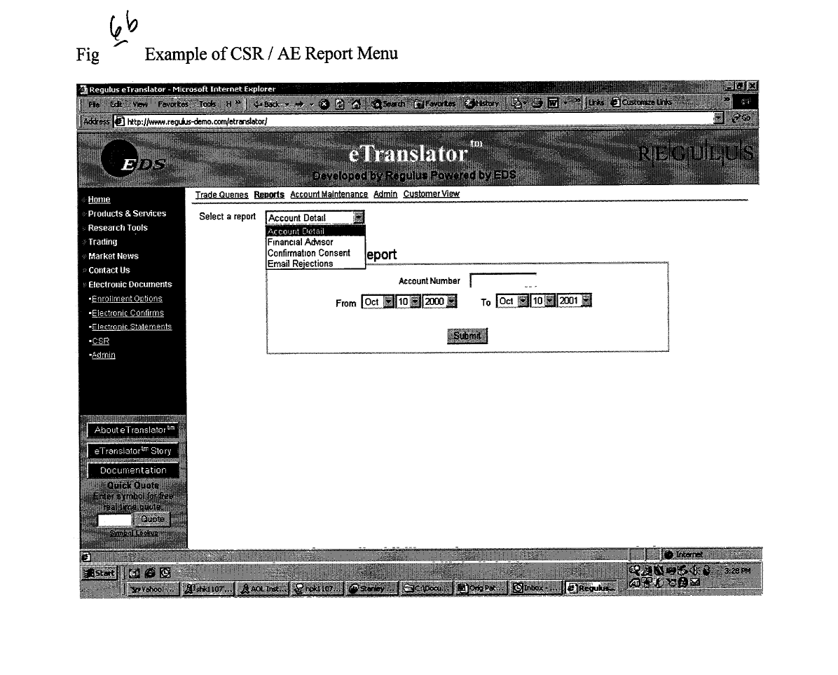

The nine queries appear as a list of menu items on the same page. The user makes a selection from this menu and a query type parameter is inserted in the call to identify which pre-programmed query the user has selected. Of the nine queries four will have an intermediate screen for making a specific trade request based on a finite set of variable parameters, such as account number, social security number and user name. The default screen for a CSR or AE user will be, “Trades By Account” query screen. An example of the CSR/AE query selection screen is shown in FIG. 6a.

Queries:

The CSR or AE user will also be able to select one of the query links on the side bar menu as follows:

| | |
|---|---|
| A. Trades By Account | By Account and Date |
| B. Trades By SSN | By SSN and Date/Intermediate Screen |
| C. Trades By Trader Name | By Trader Name and Date/Intermediate |
| | Screen |
| D. Trades By CUSIP | By CUSIP, SSN and Date/Intermediate |
| | Screen |
| E. Trades By Transaction | By Transaction Number and Date/ |
| Number | Intermediate Screen |
| F. Trades By Symbol Ticker | By Account, Ticker Symbol and Date |
| G. Unreviewed Trades By Acct | By Account and Date |
| Number | |
| H. Mail Delivery By Acct | By Account and Date |
| Number | |
| I. Consent History By Acct | By Account and Date |
| Number | |

Reports

An advantageous feature made possible by virtue of the data residing in the database to support the electronic documents, is a management reporting capability. The report generator creates a PDF formatted document which is displayed in the user's browser window. A representative report menu is shown in FIG. 6b. The submit button calls a servlet which verifies the parameters are valid and either calls the program to generate the report or returns an error message to the browser. To print the report, the user hits the “Print” button and the output will be printed in the same format as the PDF display on the screen.

The CSR and AE report options include the following:

Summary of Correspondent/Company Activity

Broker Blotter

E-mail Delivery Rejections

Account Detail by Correspondent

Summary of Office Activity

Electronic Confirmation Consent

8. Audit History (Process 800)

SEC guidelines also require that on-line brokers must ensure that customer consent regarding electronic delivery is not violated and that broker/dealer personnel are supervised in this regard. The inventive system provides a complete, auditable log of consent and de-consent history to provide an enforcement tool for the broker/dealer and protection of the customer against any violation of the consent and de-consent instructions. This log is created by actions initiated by the user as described in process 200. The system solution is a unique “Daily Consent Log” database containing a record of each individual customer instruction to receive or not receive trade confirmations electronically. This feature will maintain proof that the regulatory requirements for obtaining consent have been met and can be retrieved by customer service personnel at any time.

The Consent History database contains the collection of daily log activity expressed as the account number, account holder name, transaction date and status of consent, expressed as “Electronic Consent” or “Rescind Electronic Consent.” From this information, the brokerage can confirm whether it was required to supply the customer with a printed and mailed document, or if delivery of electronic documents via the Internet was in conformance with the customer's wishes.

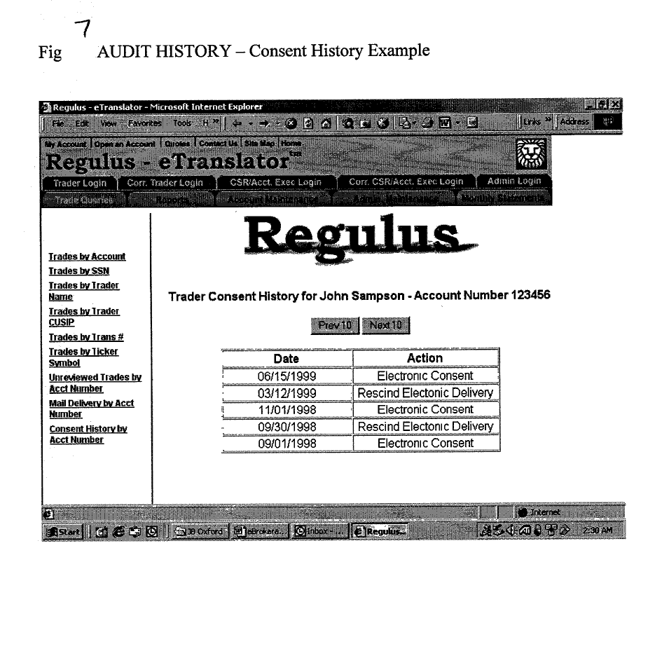

An example of the Audit History report for Customer Consent History is shown in FIG. 7. The other Audit History Reports are the “Unreviewed Trades by Account Number,” and “Mailed Delivery By Account Number” which appear in the left hand menu of FIG. 7 and are similarly accessed by clicking on the required report menu item.

9. Funds Transfer (Process 900)

Advantageously, the system also provides an electronic funds transfer feature that is a link between a customer's bank account and their trading account. This requires a user interface screen that complies with data capture requirements of any number of third-party commercial on-line funds transfer intermediaries that link the brokerage trading account for each user to the customer's bank account via the ACH automated network. This function is generally available in the marketplace and no further description is necessary here The funds transfer process is implemented via a proprietary third-party interface program that can be obtained by a user of a host system constructed in accord with the present invention.

I claim:

1. An information system for electronic trade management on an electronic network, said electronic network comprising a host system, a broker system and a trader system,
said host system having a database and a host computer running software routines that are triggered by messages received from the broker system and the trader system,
said broker system communicating trade data to the host computer via the electronic network,
said host system providing access via the trader system and broker system to the database for authorized users,
wherein the software routines in the host computer include a presentment routine that receives the trade data from the broker system, then formats and stores the data into the database; a notification routine that communicates notice of a new trade to the trader system, a consent routine that controls access to the database by the trader system; and a data review routine that provides access to stored data by the trader system.

2. An information system as in claim 1, wherein the broker system communicates statement data to the host computer via the electronic network, and the presentment routine receives the statement data from the broker system, then formats and stores the data into the database.

3. An information system as in claim 1, wherein the consent routine allows a user to consent to receiving trade-related documents electronically with notification of same and to allow a user to revoke consent to receiving trade-related documents electronically and further wherein the host computer maintains a log of consent history for each user.

4. An information system as in claim 3, further comprising an audit routine that controls access to the log of consent history.

5. An information system as in claim 1, further comprising an access routine that provides encrypted authentication of users to permit access to the database by the trader system.

6. An information system as in claim 1, wherein the presentment routine modifies the trade data for normalization into a database-ready format.

7. An information system as in claim 2, wherein the presentment routine modifies the statement data for normalization into a database-ready format.

8. An information system as in claim 7, wherein the presentment routine parses, transmits and loads statement data into database tables having multiple key values for document retrieval.

9. An information system as in claim 8, wherein the presentment routine recompiles the trade and statement data upon receipt of commands and key values from the broker system.

10. An information system as in claim 8, wherein the presentment routine recompiles the trade and statement data upon receipt of commands and key values from the trader system.

11. An information system as in claim 3, wherein the consent routine detects an enrollment status of the user and controls access to the database in correspondence with the log of consent history for each user.

12. An information system as in claim 3, wherein the notification routine generates a failed-delivery detection log when electronic notification has failed, and initiates an alternative document delivery routine for users specified in the failed-delivery detection log.

13. An information system as in claim 1, wherein the notification routines includes a trader access detection routine for determining whether the user has accessed the database for each new trade record, and updating an audit history log for unaccessed data.

14. An information system as in claim 1, wherein the database includes an e-mail address record and update routine for each user for use by the notification routine.

15. An information system as in claim 3, wherein the data review routine includes a set of query routines that provide selected views and file export options of the stored trade data and statement data.

16. An information system as in claim 15, wherein the query routines include report routines and file export options having selection criteria and formatting routines for compiling and presenting pdf-formatted reports for display.

17. An information system as in claim 1, wherein an administrative routine is provided in the host computer that controls access to the database by the broker computer.

18. An information system as in claim 6, wherein the trade data is automatically transmitted from the broker system to the host system

19. An information system as in claim 7, wherein the statement data is automatically transmitted from the broker system to the host system.

20. An information system as in claim 12, wherein the notification routine includes automatic repeated delivery attempts for a system-specified time, after which the alternate document delivery routine is initiated.

21. An information system as in claim 3, wherein the notification routine interacts with the consent routine to initiate the alternate document delivery routine for users that have not consented to electronic notification.

22. An information system as in claim 3, wherein if a user has not consented to electronic notification, a consent form and a terms and conditions form are communicated to the trader system.
